(19) United States
(12) Patent Application Publication
(10) Pub. No.: US 2022/0357481 A1
(43) Pub. Date: Nov. 10, 2022

(54) INFORMATION PROCESSING DEVICE AND METHOD

(71) Applicant: Bayer CropScience K.K., Tokyo (JP)

(72) Inventors: Satoshi ITO, Tokyo (JP); Victoria SMART, Tokyo (JP); Mehul BANSAL, Tokyo (JP)

(73) Assignee: Bayer CropScience K.K., Tokyo (JP)

(21) Appl. No.: 17/620,647

(22) PCT Filed: May 29, 2020
(86) PCT No.: PCT/JP2020/021367

§ 371 Date: Dec. 17, 2021

(30) Foreign Application Priority Data
Jun. 17, 2019 (JP) 2019-111699

(51) Int. Cl. G01W 1/10; G06Q 50/02; A01G 9/24

(52) U.S. Cl. CPC G01W 1/10; G06Q 50/02; A01G 9/24

(57) ABSTRACT

An information processing device is configured to acquire prediction information of a weather condition outside a plastic greenhouse and cultivation information of produce inside the plastic greenhouse and predict an environmental condition inside the plastic greenhouse based on the prediction information of the weather condition and the cultivation information. Cultivation information includes at least one item of information from among the type of produce, a cultivation amount, a growth state, and a cultivation ground. A prediction model may be generated with machine learning.

### CROSS REFERENCE TO RELATED APPLICATIONS

This application is a national stage application under 35 U.S.C. § 371 of International Application No. PCT/JP2020/021367, filed internationally on May 29, 2020, which claims the benefit of priority to Japanese Application No. 2019-111699, filed Jun. 17, 2019.

### FIELD OF THE INVENTION

The present invention relates to an information processing device and method.

### BACKGROUND OF THE INVENTION

In protected horticulture in a plastic greenhouse, environmental conditions inside the plastic greenhouse are predicted. By predicting the environmental conditions, it is possible to predict yields of produce and risks of pest damage. A measure which involves adjusting the environmental conditions inside the plastic greenhouse by means of air conditioning or the like is also feasible in order to avoid the risk of predicted pest damage.

For example, the conditions inside a plastic greenhouse may be predicted on based on past performance of a control device installed in the plastic greenhouse, and sensor information may be obtained by means of sensors inside the plastic greenhouse (see JP 2018-99067 A). Furthermore, a greenhouse may be temperature-controlled based on input from an external air sensor, a greenhouse-internal temperature sensor, and a sunlight sensor, etc. (see JP 2002-48354 A).

### SUMMARY OF THE INVENTION

Weather conditions outside plastic greenhouses have a considerable effect on the environmental conditions inside the plastic greenhouses, but providing sensors around numerous plastic greenhouses in order to monitor the weather conditions entails introduction and maintenance costs. Furthermore, even if sensors are provided, predictions may be made several days ahead or several weeks ahead; there may be considerable changes in the weather during that time, limiting the accuracy of the predictions. It is difficult to improve the prediction accuracy by measurement values of sensors alone.

The objective of the present disclosure lies in improving the accuracy of predicting environmental conditions by means of a simple configuration.

In some embodiments, an information processing device is provided, the information processing device comprising: an information acquisition unit for acquiring prediction information of a weather condition outside a plastic greenhouse and cultivation information of produce inside the plastic greenhouse; and a prediction unit for predicting an environmental condition inside the plastic greenhouse based on the prediction information of the weather condition and the cultivation information.

In some embodiments, a method for predicting an environmental condition inside a plastic greenhouse is provided, the method comprising: acquiring prediction information of a weather condition outside the plastic greenhouse and cultivation information of produce inside the plastic greenhouse; and predicting the environmental condition inside the plastic greenhouse based on the prediction information of the weather condition and the cultivation information.

The present disclosure improves the accuracy of predictions of environmental conditions by means of a simple configuration.

### BRIEF DESCRIPTION OF THE DRAWINGS

FIG. 1 shows a configuration of an information provision system comprising an information processing server, according to some embodiments.

FIG. 2 shows a configuration of the information processing server, according to some embodiments.

FIG. 3 shows a processing sequence by which the information processing server generates a prediction model, according to some embodiments.

FIG. 4 shows a processing sequence by which the information processing server predicts an environmental condition inside a plastic greenhouse, according to some embodiments.

### DETAILED DESCRIPTION OF THE INVENTION

An embodiment of the information processing device and method according to the present disclosure will be described below with reference to the drawings. The configuration described below is an example (representative example) of one mode of embodiment of the present invention, and the present invention is not limited to the configuration described below.

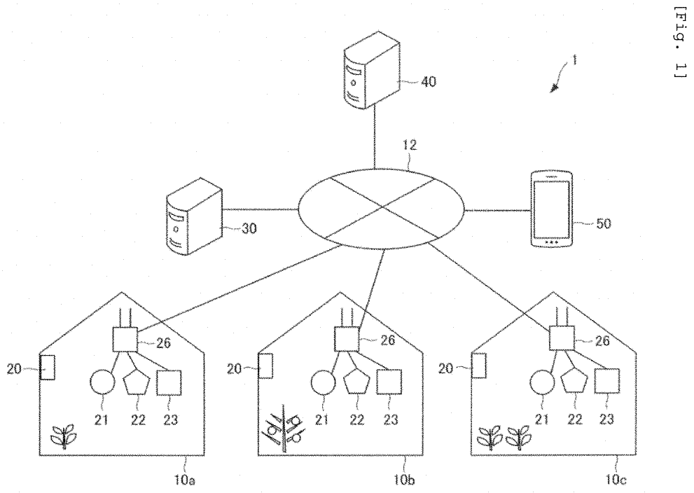

FIG. 1 shows an information provision system 1 according to some embodiments of the present disclosure.

In some embodiments, the information provision system 1 may predict environmental conditions inside plastic greenhouses 10a-10c based on prediction information of weather conditions outside the plastic greenhouses 10a-10c and cultivation information of produce inside the plastic greenhouses 10a-10c. FIG. 1 shows an example in which prediction information for the three plastic greenhouses 10a-10c is provided, but there is no particular limitation as to the number of plastic greenhouses which may be provided with the prediction information, and the prediction information may be provided to one or more plastic greenhouses.

As shown in FIG. 1, the information provision system 1 comprise: a plurality of sensors 21-23, a communication device 26, a weather server 30, an information processing server 40, and a user terminal 50. The communication device 26, weather server 30, information processing server 40 and user terminal 50 may be communicably connected to one another via a network 12. In some embodiments, the network 12 may comprise the Internet, a telephone network, or a LAN (local area network), etc.

In some embodiments, the sensors 21-23 are provided inside the plastic greenhouses 10a-10c, and measure environmental conditions inside the plastic greenhouses 10a-10c at fixed intervals (e.g., intervals of 10 minutes or the like). Examples of environmental conditions which may be cited include: temperature, relative humidity, solar irradiance, carbon dioxide concentration, wind speed, terrestrial heat, and soil moisture content, etc. In embodiments, the sensor 21 measures temperature, the sensor 22 measures relative humidity, and the sensor 23 measures solar irradiance. Sensors for measuring other environmental conditions such as carbon dioxide concentration may equally be provided.

In some embodiments, the communication device 26 sends the temperature, relative humidity, solar irradiance, etc. measured by the respective sensors 21-23 to the information processing server 40 as measurement information of the environmental conditions inside the plastic greenhouses 10a-10c.

In some embodiments, a control device 20 for adjusting the environmental conditions may be provided inside the plastic greenhouses 10a-10c. The communication device 26 may acquire required information from the control device 20 to generate operating information of the control device 20 and may send this operating information to the information processing server 40. An example of the control device 20 which may be cited is a device for controlling opening and closing of an air conductor, a sprinkler, a sun-shading curtain, or a window, etc.

In some embodiments, communication between the communication device 26, the sensors 21-23, and control device 20 takes place by wireless communication such as BLE (Bluetooth (registered trademark) Low Energy), or Wi-Fi (registered trademark), but wired communication is equally possible.

In some embodiments, the weather server 30 sends prediction information of weather conditions outside the plastic greenhouses 10a-10c to the information processing server 40. Examples of weather conditions which may be cited include air temperature, relative humidity, solar irradiance, rainfall, and wind speed, etc. in each region. The prediction information may be a weather forecast. The weather server 30 may send not only prediction information to the information processing server 40, but also measurement information of weather conditions measured around the plastic greenhouses 10a-10c.

In some embodiments, the information processing server 40 is an information processing device which acquires the prediction information of the weather conditions outside the plastic greenhouses 10a-10c and cultivation information of produce inside the plastic greenhouses 10a-10c and predicts the environmental conditions inside the plastic greenhouses 10a-10c based on the prediction information and cultivation information acquired. The information processing server 40 is capable of generating and outputting the prediction information of the environmental conditions on the basis of a prediction result.

In some embodiments, the user terminal 50 is a mobile telephone, a tablet, or a PC (personal computer), etc., for example. In some embodiments, the user terminal 50 is used by a user such as a farmer managing the plastic greenhouses 10a-10c, and displays the prediction information sent from the information processing server 40.

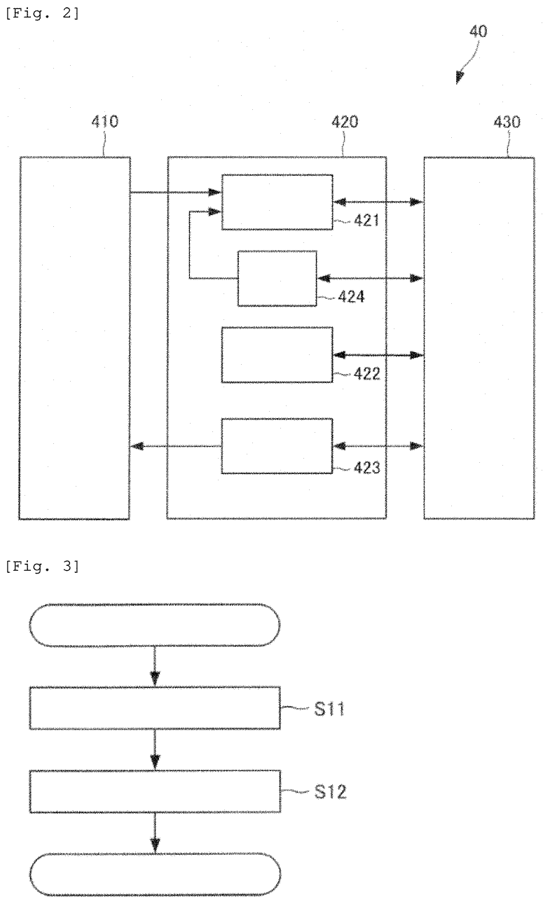

FIG. 2 shows a configuration of the information processing server 40, according to some embodiments.

As shown in FIG. 2, the information processing server may comprise a communication unit 410, a control unit 420, and a memory unit 430.

In some embodiments, the communication unit 410 is an interface for communicating with external devices on the network 12, such as the communication device 26, the weather server 30, and the user terminal 50.

In some embodiments, the control unit 420 controls operation of the information processing server 40.

In some embodiments, the control unit 420 makes predictions of the environmental conditions inside the plastic greenhouses 10a-10c. For the purposes of this prediction, the control unit 420 comprises an information acquisition unit 421, a learning unit 422, a prediction unit 423 and an information estimation unit 424, as shown in FIG. 2. In some embodiments, the information acquisition unit 421, the learning unit 422, the prediction unit 423 and the information estimation unit 424 may be realized by means of software processing in which a processor such as a CPU (central processing unit) executes a program stored in the memory unit 430 or another recording medium such as a memory. In some embodiments, the above units may be realized by means of hardware such as an ASIC (application specific integrated circuit).

In some embodiments, the information acquisition unit 421 acquires the prediction information of the weather conditions from the weather server 30 via the communication unit 410, and acquires the cultivation information of the produce in each plastic greenhouse 10a-10c estimated by means of the information estimation unit 424. In some embodiments, the cultivation information is information relating to cultivation conditions of the produce. In some embodiments, the information acquisition unit 421 saves the acquired items of information in the memory unit 430.

In some embodiments, the information acquisition unit 421 may acquire measurement information of the environmental conditions inside the plastic greenhouses 10a-10c and operating information of the control device 20 from the communication device 26, and may acquire the measurement information of the weather conditions from the weather server 30. In some embodiments, the information acquisition unit 421 may acquire the measurement information at predetermined intervals, such as intervals of 10 minutes, for example.

In some embodiments, when the prediction information of the weather conditions and the cultivation information saved in the memory unit 430 are input to the learning unit 422, the learning unit 422 generates a prediction model for outputting a prediction result of the environmental conditions inside the plastic greenhouses. The prediction model generated may be saved in the memory unit 430.

In some embodiments, the prediction unit 423 may predict the environmental conditions inside the plastic greenhouses 10a-10c based on the prediction information of the weather conditions and the cultivation information acquired by means of the information acquisition unit 421. Specifically, the prediction unit 423 may input the prediction information of the weather conditions and the cultivation information to the prediction model generated by the learning unit 422 and can thereby acquire a prediction result of the environmental conditions inside the plastic greenhouses 10a-10c.

In some embodiments, the information estimation unit 424 generates the cultivation information by estimating a cultivation state of the produce inside the plastic greenhouses. The information estimation unit 424 may generate the cultivation information at any observation time in accordance with a request from the information acquisition unit 421, and may provide this cultivation information to the information acquisition unit 421.

In some embodiments, the memory unit 430 stores the various items of information acquired by means of the information acquisition unit 421, specifically, the prediction information and measurement information of the weather conditions, measurement information of the environmental conditions inside the plastic greenhouses 10a-10c, and cultivation information of the produce, etc.

In some embodiments, the memory unit 430 stores the prediction model generated by means of the learning unit 422. A large-capacity storage medium such as a hard disk may be used as the memory unit 430.

In some embodiments, the information processing server 40 generates the prediction model from past measurement information of the weather conditions and cultivation information, and predicts the environmental conditions inside the plastic greenhouses 10a-10c with the prediction model generated.

FIG. 3 shows a processing sequence by which the information processing server 40 generates the prediction model, according to some embodiments.

As shown in FIG. 3, the information acquisition unit 421 of the information processing server 40 may acquire the information required to generate the prediction model. Specifically, the information acquisition unit 421 may acquire the measurement information of the weather conditions outside the plastic greenhouses 10a-10c from the weather server 30. In some embodiments, the information acquisition unit 421 acquires the cultivation information of the produce inside the plastic greenhouses 10a-10c from the information estimation unit 424, and acquires the measurement information of the environmental conditions inside the plastic greenhouses 10a-10c from the communication device 26 (step S11).

In some embodiments, the cultivation information is information relating to cultivation conditions of the produce, and includes at least one item of information from among the type of produce, cultivation amount, growth condition, and cultivation ground, for example. The type of produce is a category such as cucumber or tomato, for example. Examples of the cultivation amount that may be cited include the area of the cultivated land, number of plants, and planting density in the plastic greenhouses 10a-10c. The planting density may be calculated by dividing the number of plants by the area of the cultivated land. Examples of growth conditions that may be cited include the number of days elapsed from the planting date, and a growth stage estimated from the number of days since planting. The cultivation ground is a category such as soil culture or water culture, for example.

This cultivation information may be information which is input from the user terminal 50, for example, and saved in advance in the memory unit 430 of the information processing server 40. In some embodiments, the information estimation unit 424 generates the cultivation information at any observation time by estimating a subsequent cultivation state from the cultivation information which was initially saved. Specifically, the information estimation unit 424 determines the growth stage by counting the number of days elapsed from the planting date, which is in the cultivation information, until the observation time as the number of days since planting, and comparing the number of days since planting with a threshold.

Next, the learning unit 22 generates the prediction model for outputting the prediction result of the environmental conditions inside the plastic greenhouses (step S12). The prediction model may be a prediction formula for outputting predicted values of the temperature and humidity, etc. inside the plastic greenhouses 10a-10c by using, as variables, the prediction information of the weather conditions and the cultivation information, etc., or the prediction model may be a table in which predicted values are pre-established in relation to variables.

The functions represented by the following formulae (1) and (2) may be used for the prediction formula, for example.

Tᵢₙ=A₁×T³ₒᵤₜ+A₂×S+Z₁(t) (1)

Hᵢₙ=B₁×Aₒᵤₜ+B₂×S+Z₂(t)+M(t) (2)

The variables in the formulae (1) and (2) above are defined as follows:
Tᵢₙ: predicted value of the temperature inside the plastic greenhouse
Tₒᵤₜ: predicted value of the temperature outside the plastic greenhouse
S: predicted value of solar irradiance outside the plastic greenhouse
Z₁(t) and Z₂(t): coefficients corresponding to the time of predicting the environmental conditions
A₁, A₂, B₁ and B₂: coefficients
Hᵢₙ: predicted value of the relative humidity inside the plastic greenhouse
Hₒᵤₜ: predicted value of the relative humidity outside the plastic greenhouse
M(t): coefficient corresponding to the month to which the time of predicting the environmental conditions belongs
   Values determined by means of machine learning, for example, may be used as A₁, A₂, B₁, B₂, Z₁(t), Z₂(t) and M(t) above.

In some embodiments, the prediction model may be a model which is generated by means of machine learning, by using, as input data, the measurement information of the weather conditions and the cultivation information, and by using, as teaching data, the measurement information of the environmental conditions inside the plastic greenhouses 10a-10c. A prediction model afforded by machine learning has a higher prediction accuracy and is therefore preferable.

Examples of machine learning for generating the prediction model that may be cited include: linear regression, a filter such as a Kalman filter, a support vector machine, a decision tree such as a random forest, a nearest neighbor method, a neural network such as deep learning, and a Bayesian network. One of the above types of machine learning may be used alone, or two or more may be combined for use. The type of machine learning may be appropriately selected in accordance with characteristics thereof. For example, a Kalman filter makes it possible to adjust parameters constituting the prediction model in such a way as to reduce differences between prediction data and measurement information, while also readily responding to changes in environmental conditions over time. Furthermore, a neural network is better able to respond to non-linear changes than a linear model or a Kalman filter, and can also easily respond to sudden modifications of temperature settings by the control device 20, etc.

In some embodiments, the learning unit 422 may use time information indicating an observation time of the measurement information of the weather conditions and the cultivation information as one item of input data, and may use time information indicating an observation time of the measurement information of the environmental conditions as teaching data. For example, when measurement information of the weather conditions measured at 17:00 hours on April 5 has been acquired by the information acquisition unit 421, the learning unit 422 uses time information for 17:00 hours on April 5 as one item of input data. The learning unit 422 may also use time information at a time measured in the same way for the environmental conditions as one item of input data. In some embodiments, the observation time of the cultivation information is a time at which the cultivation state was estimated by means of the information estimation unit 424.

Solar irradiance may be present or absent, temperature differences may arise over the course of a day, and environmental conditions such as temperature and humidity in the interior of the plastic greenhouses 10a-10c fluctuate with the seasons throughout the year, so it is possible to further improve the prediction accuracy of the environmental conditions at a time for which a prediction is to be made by using time information. It should be noted that when the time information is information including not only the time of day but also the month and date, as indicated above, it is possible to make a prediction using a pattern of chronological changes in environmental conditions for a longer span. The time information is not limited to a specific time of day, and may equally be information indicating a time slot such as 17:00 hours to 19:00 hours.

In some embodiments, the learning unit 422 may generate the prediction model by using, as input data, information affecting the environmental conditions inside the plastic greenhouses, in addition to the abovementioned measurement information of the weather conditions and cultivation information. By using multiple items of information, it is possible to make a comprehensive prediction, further improving the prediction accuracy.

In some embodiments, the information acquisition unit 421 may further acquire identification information of the plastic greenhouses 10a-10c, and the learning unit 422 may further use the identification information of the plastic greenhouses as one item of input data. Specifically, when the information acquisition unit 421 acquires the measurement information of the weather conditions and the cultivation information around the plastic greenhouse 10a, it also acquires the identification information of the plastic greenhouse 10a. The environmental conditions inside the plastic greenhouses vary according to an installation location of the individual plastic greenhouses, a structure thereof, whether or not a control device is installed therein, or the performance of such a control device, etc., so the prediction accuracy of the environmental conditions of each plastic greenhouse 10a-10c can be further improved by using identification information of the plastic greenhouses.

In some embodiments, the environmental conditions inside the plastic greenhouses may be similar, depending on the region in which the plastic greenhouses are installed, the size thereof, and installation conditions such as equipment, so the plastic greenhouses 10a-10c may be grouped according to the installation conditions thereof. For example, when the plastic greenhouses 10a and 10c are installed in the same region and the sizes thereof are also within a certain range, the plastic greenhouses 10a and 10c are classified in the same group, and identification information for the same group is provided thereto. The provision of groupings and identification information may be performed by the learning unit 422 by means of machine learning, for example, or it may be performed manually by a manager of the information processing server 40. When a group classification is made in this way, the information acquisition unit 421 may further acquire identification information of the group to which each of the plastic greenhouses 10a-10c belongs, and the learning unit 422 may further use the group identification information as one item of input data. By using the group identification information, it is possible to further improve the prediction accuracy of the environmental conditions of the plastic greenhouses 10a-10c belonging to each group. Furthermore, if the measurement information also includes noise, the effect of the noise can be reduced because a prediction is made in accordance with a group tendency.

In some embodiments, the information acquisition unit 421 may further acquire operating information of the control device 20 from the communication device 26, and the learning unit 422 may further use the operating information as one item of input data. Examples of the operating information that may be cited include: whether or not a control device 20 is installed, the type of control device 20, an operating condition indicating whether the control device 20 is stopped or operating, a target temperature, and a target humidity, etc. Operation of the control device 20 alters the environmental conditions inside the plastic greenhouses 10a-10c, so it is possible to further improve the prediction accuracy of the environmental conditions of the plastic greenhouses 10a-10c by using this operating information to generate the prediction model.

In some embodiments, the learning unit 422 preferably updates the prediction model saved in the memory unit 430 by performing the abovementioned processing periodically or at any time. As a result, predictions based on the most recent trends can be made.

In some embodiments, the information acquisition unit 421 acquires the prediction information of the weather conditions at a prediction time which will be described later and the cultivation information, after which the information acquisition unit 421 acquires the measurement information of the environmental conditions at the prediction time of the weather conditions, and may also update the prediction model by using this prediction information as input data and by using this measurement information as teaching data. In this case, the prediction model may be corrected in such a way as to reduce any divergence between the prediction data and the measurement information.

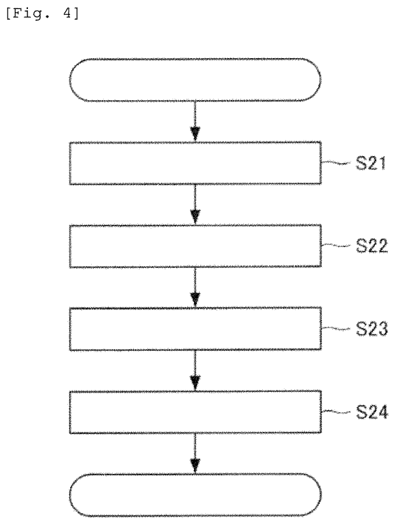

FIG. 4 shows the processing sequence by which the information processing server 40 predicts the environmental conditions inside the plastic greenhouses 10a-10c, according to some embodiments.

As shown in FIG. 4, the prediction unit 423 in the information processing server 40 may receive an instruction as to which plastic greenhouse will be the subject of a prediction by the prediction unit 423. The prediction unit 423 may also receive an instruction of the time for which the prediction is to be made (step S21). The instruction may be received from the user terminal 50, or, when predictions are made at fixed time intervals, the instruction may be automatically received while the time for which the prediction is to be made is changed at the fixed time intervals.

Next, the information acquisition unit 421 may acquire the prediction information of the weather conditions from the weather server 30. In some embodiments, the prediction information of the weather conditions is not only information which has actually been measured, but also predicted information, such as a weather forecast, for example. Furthermore, the information acquisition unit 421 acquires from the information estimation unit 424 the cultivation information at the time for which the prediction is to be made in the designated plastic greenhouse (step S22).

In some embodiments, the prediction unit 423 inputs, to the prediction model, the acquired prediction information of the weather conditions, cultivation information, and time information indicating the time for which a prediction is to be made, and thereby acquires a prediction result of the environmental conditions inside the plastic greenhouse at the time for which a prediction is to be made (step S23). In some embodiments, the prediction unit 423 generates and outputs prediction information of the environmental conditions in accordance with the prediction result (step S24).

Examples of the prediction information which may be cited include predicted values of the temperature, relative humidity, solar irradiance, carbon dioxide concentration and soil water content, etc. inside the plastic greenhouse at the designated time, or a graph of those predicted values, etc. In order to predict changes in the environmental conditions, the prediction unit 423 may also generate, as the prediction information, a graph of predicted values obtained by shifting the prediction times by fixed time units such as one day.

In some embodiments, the prediction information may be sent to the control device 20 of the plastic greenhouse for which a prediction has been made, and may be used for controlling the environmental conditions inside that plastic greenhouse, and the prediction information may equally be sent to the user terminal 50 and displayed thereon so that the user can inspect the prediction information.

As described above, the information processing server 40 according to this mode of embodiment uses the prediction information of the weather conditions and the cultivation information in order to predict the environmental conditions inside the plastic greenhouses 10a-10c. Prediction information such as a weather forecast is sufficient for the weather conditions, and there is no need for measurement devices such as sensors. In some embodiments, the cultivation information is inferred, so there is no need to input cultivation information each time a prediction is made, as long as basic information is input once, and therefore predictions can be made using a simple configuration. Furthermore, the predictions are made on the basis of not only current weather conditions, but also prediction information of the weather conditions, while predictions are also made on the basis of the cultivation information which has a considerable effect on the environmental conditions inside the plastic greenhouses 10a-10c, and as a result it is possible to improve the prediction accuracy of the environmental conditions.

A preferred mode of embodiment of the present invention was described above, but the present invention is not limited by this mode of embodiment, and a number of variations and modifications may be made within the scope of the essential point thereof.

In some embodiments, the learning unit 422 may be provided in an external device such as another server, rather than in the information processing server 40, and the information processing server 40 may acquire the prediction model generated in the external device and store the prediction model in the memory unit 430.

1: An information processing device comprising a processor configured to:
acquire prediction information of a weather condition outside a plastic greenhouse and cultivation information of produce inside the plastic greenhouse; and
predict an environmental condition inside the plastic greenhouse based on the prediction information of the weather condition and the cultivation information.

2: The information processing device of claim 1, wherein the processor is further configured to:
acquire identification information of the plastic greenhouse, and
predict the environmental condition based on the prediction information of the weather condition, the cultivation information, and the identification information of the plastic greenhouse.

3: The information processing device of claim 1, wherein, when plastic greenhouses have been grouped according to an installation condition of the plastic greenhouses, the processor is further configured to:
acquires identification information of the group to which a plastic greenhouse belongs, and
predict the environmental condition based on the prediction information of the weather condition, the cultivation information, and the group identification information.

4: The information processing device of claim 1, wherein the processor is further configured to:
acquire operating information of a control device (20) for controlling the environmental condition in the plastic greenhouse, and
predict the environmental condition based on the prediction information of the weather condition, the cultivation information, and the operating information.

5: The information processing device of claim 1, wherein the cultivation information includes at least one item of information from among the type of produce, a cultivation amount, a growth state, and a cultivation ground.

6: The information processing device of claim 1, wherein, when the processor acquires a plurality of items of information including the prediction information of the weather condition, the cultivation information, and time information indicating a time for which a prediction is to be made, said processor is further configured to predict the environmental condition inside the plastic greenhouse by using a prediction model which outputs a prediction result of the environmental condition inside the plastic greenhouse for the time for which a prediction is to be made.

7: The information processing device of claim 6, wherein the processor is configured to generate the prediction model with machine learning, by using, as input data, a plurality of items of information including measurement information of the weather condition outside the plastic greenhouse and the cultivation information inside the plastic greenhouse, and time information indicating an observation time of the measurement information and the cultivation information, and by using, as teaching data, measurement information of the environmental condition inside the greenhouse and time information indicating an observation time of that measurement information.

8: A method for predicting an environmental condition inside a plastic greenhouse, the method comprising:
acquiring prediction information of a weather condition outside the plastic greenhouse, and cultivation information of produce inside the plastic greenhouse; and
predicting the environmental condition inside the plastic greenhouse based on the prediction information of the weather condition and the cultivation information.
